(19) United States
(12) Patent Application Publication
(10) Pub. No.: US 2022/0032998 A1
(43) Pub. Date: Feb. 3, 2022

(54) Method for determining a roadway condition and vehicle having at least two wheel-selective steering actuators

(71) Applicant: Schaeffler Technologies AG & Co. KG, Herzogenaurach (DE)

(72) Inventor: Benjamin Wuebbolt-Gorbatenko, Erlangen (DE)

(73) Assignee: Schaeffler Technologies AG & Co. KG, Herzogenaurach (DE)

(21) Appl. No.: 17/276,523

(22) PCT Filed: Sep. 16, 2019
(86) PCT No.: PCT/DE2019/100817

§ 371 Date: Mar. 16, 2021

(30) Foreign Application Priority Data
Oct. 9, 2018 (DE) 10 2018 124 866.0

(51) Int. Cl. B62D 6/00

(52) U.S. Cl. CPC B62D 6/008; B62D 6/006

(57) ABSTRACT

A method determines a roadway condition using steering actuators, wherein at least two steering actuators are arranged on each vehicle wheel. Measurement variables of the first and second steering actuators are sensed. The sensed measurement variables of the two steering actuators are compared with one another and, an inhomogeneity signal is determined from the deviation between the sensed measurement variables of the two steering actuators. If the inhomogeneity signal lies within a tolerance range, a homogeneous roadway condition exists. If the inhomogeneity signal lies outside the tolerance range, an inhomogeneous roadway condition exists.

### CROSS-REFERENCE TO RELATED APPLICATIONS

This application is the U.S. National Phase of PCT Appln. No. PCT/DE2019/100817 filed Sep. 16, 2019, which claims priority to DE 10 2018 124 866.0 filed Oct. 9, 2018, the entire disclosures of which are incorporated by reference herein.

### TECHNICAL FIELD

The present disclosure relates to a method for determining a roadway condition with the aid of values sensed on steering actuators. The disclosure also relates to a vehicle that is suitable for carrying out such a method, in particular a vehicle with an electric motor drive and electronic control of individual wheels.

### BACKGROUND

Depending on the roadway condition, roadways have different coefficients of friction that are influenced by various factors. The first factor is the weather, for example the roadway can be dry, wet, or icy. Furthermore, the roadway condition will be influenced by age, wherein ruts and slippery areas can develop. Unexpected materials can also be deposited on the roadway, for example contamination by oil or sediments. Such factors can occur over a large area, but also selectively, so that the roadway condition is inhomogeneous and has different coefficients of friction.

Inhomogeneous roadway condition is generally understood here to mean a difference in the coefficients of friction between the two tires on an axle, wherein the respective coefficients of friction between road surfaces and tires are considered. Different distribution of the coefficient of friction of a roadway is also referred to as a μ-split situation.

Hazardous situations can arise in the case of inhomogeneous roadway conditions or roadway properties and, for example, an inappropriate driving style. Starting or accelerating can also be negatively influenced. To mitigate or prevent hazardous situations, various assistance systems that are installed in the vehicle are known. These include vehicle control systems such as traction, braking and stability control systems, in particular ESC (electronic stability control), TCS (traction control system) or ABS (anti-lock braking system). Knowing the roadway properties enables the vehicle control systems to prevent hazards by issuing appropriate driver warnings or to stabilize the vehicle in hazardous situations through braking or steering interventions.

Knowing the roadway conditions is also very important for autonomous driving.

In principle, the roadway condition is sensed by means of sensors or predicted by estimating the respective μ-value or coefficients of friction between the road surface and the tires using models that are supplied with condition information for the vehicle.

DE 42 39 177 A1 describes a method for adapting an anti-lock control to the respective roadway conditions. The timing of the vehicle deceleration and the mean slip is determined by sensing the respective wheel rotation behavior and the vehicle reference speed. The phase relation of the vehicle deceleration and the mean slip are compared with one another. The lane characteristics (type A, type B; wherein type B is a road with μ-slip characteristic without a pronounced maximum) is determined by the respective phase relation.

DE 10 2015 212 948 A1 shows a drive torque compensation in μ-split situations, wherein a method for improving the acceleration behavior of a vehicle is described. A slippage of a driven wheel of the vehicle is reduced by a braking torque applied to the wheel of the vehicle. The method comprises determining an index such that a first driven wheel of the vehicle is located on a first side of the roadway so as to enable a lower frictional connection with the first driven wheel than on a second side of the roadway with a second driven wheel of the vehicle. The method also includes determining, based on the index, whether a μ-split situation exists. If the μ-split situation exists, a braking compensation torque is provided.

A wheel-selective traction drive is known from DE 10 2016 215 793 B4, which enables the transverse dynamics of the vehicle to be influenced by specifically distributing the drive power to individual wheels by varying primarily longitudinally dynamic variables. Through the use of wheel-selective traction drives on the steered axle of a vehicle, a turning in of the wheels can be produced through a targeted setting of differences in drive power.

A method for determining an inhomogeneous roadway is known from DE 10 2006 043 931 A1, wherein a vehicle is in a driving situation in which the roadway has different coefficients of friction (μ-split) on each side and an active ABS control and active yaw-moment limitation exists, wherein a front wheel is located on the side having a high coefficient of friction. By adhering to defined conditions, the anti-lock control provides μ-split detection that can be used by an active steering system.

DE 10 2015 211 482 A1 describes a method and a device for determining a minimum value for the coefficient of friction of a road segment. The method provides that at least one motion variable of a second vehicle that characterizes the vehicle movement is determined by means of an environment sensor system contained in a first vehicle. A minimum value for the coefficient of friction of the road segment on which the second vehicle is traveling is determined on the basis of the motion variable for the second vehicle. The spatial position of the first vehicle is also determined. Furthermore, the relative position of the second vehicle with respect to the first vehicle is determined by means of the environment sensors and the spatial position of the first vehicle. The spatial location of the second vehicle and the minimum value are stored in a database.

From DE 10 2012 112 724 A1 a method for determining a roadway condition from environment sensor data is known. To determine the roadway condition, a fusion of data from at least one device is provided, which measures a local roadway condition or coefficient of friction, with data from a camera for sensing a roadway ahead. The local roadway condition can be determined by means of a sensor.

DE 10 2017 109 649 B3 describes a method for determining the coefficient of friction of a vehicle tire on a surface. The force acting on a wheel bearing or a wheel carrier is determined when a vehicle wheel that has the wheel bearing or the wheel carrier is accelerated. An additional sensor is required to determine the force acting thereon.

### SUMMARY

It is desirable to provide a method for determining a roadway condition that does not require any additional sensors and is therefore designed to be inexpensive and yet reliable and sufficiently precise. In addition, a vehicle for carrying out this method is needed.

The method serves to determine a roadway condition, preferably by means of components already integrated into a vehicle to fulfill other functions. The vehicle has vehicle wheels, wherein a steering actuator is arranged on at least two vehicle wheels. The vehicle has at least one vehicle axle on which at least two vehicle wheels are arranged opposite one another along a (virtual) axis. The vehicle axle of two opposing vehicle wheels can consist of separate wheel carriers. The method for determining a roadway condition provides in a first step that a measurement variable of a first steering actuator is sensed. In a further method step, a measurement variable of a second steering actuator is sensed. These two sensed measurement variables represent the steering force applied by the respective steering actuator, which is complementary to the forces acting on the steered vehicle wheel due to the current roadway condition. Another method step provides that the two measurement variables of the two steering actuators are compared. A deviation or difference can be determined from the comparison, so that in a further method step an inhomogeneity signal is determined from the deviation between the sensed measurement variables of the two steering actuators. An inhomogeneity signal lying within a predetermined tolerance range represents a homogeneous roadway or a homogeneous roadway condition. An inhomogeneity signal lying outside the tolerance range represents an inhomogeneous roadway or an inhomogeneous roadway condition. Since the inhomogeneity signal is generated from measured values from two vehicle wheels arranged at a distance along a vehicle axis, leaving the predetermined tolerance range signals that the roadway condition is inhomogeneous transversely to the direction of travel of the vehicle.

The comparison of the measurement variables from the steering actuators can preferably take place by forming the difference between the measurement variables, wherein the amount of the difference forms the inhomogeneity signal. The inhomogeneity signal correlates with the different roadway condition, so that the inhomogeneity signal increases as the inhomogeneity of the road increases.

Each steering actuator preferably comprises an electric motor and a mechanical transmission element. The mechanical transmission element can be a pinion or a gear, for example. The electric motor of the steering actuator is preferably connected to a control unit.

A measuring device known per se is used to sense the measurement variable from the steering actuators. Such measuring devices are regularly integrated into steering systems. The measurement variable is preferably accessed from the electric motor of the steering actuator. The measuring device is preferably arranged on the electric motor or integrated thereinto. Alternatively, the measuring device is preferably arranged on the control unit or integrated thereinto, for example to determine the activation currents supplied to the steering actuators.

The sensed measurement variables of the steering actuators are preferably actuating torques. The actuating torque can be a steering torque. Alternatively, the sensed measurement variable of the steering actuators is preferably an electric current. In a preferred step, a steering torque can be determined from the sensed measurement variables, wherein the steering torque is used to determine the inhomogeneity signal.

The determined inhomogeneity signal is preferably used in a vehicle control system to stabilize the vehicle wheels during a slip situation or a μ-split situation. Using the inhomogeneity signal, the vehicle control system can determine a compensation torque, in particular a braking torque or a drive torque, which is applied to at least one vehicle wheel. The braking torque or drive torque to be applied is preferably determined by the vehicle control system from the inhomogeneity signal, taking into account the sensed measurement variables of the steering actuators for each individual vehicle wheel. The vehicle is advantageously stabilized by using the determined inhomogeneity signal in the vehicle control system.

The method for determining an inhomogeneous roadway condition is preferably used in vehicles having a wheel-selective steering system. The method is particularly preferably used for determining a roadway condition in vehicles with wheel-selective steer-by-wire systems that do not have a mechanical steering rod between the steering wheel and the vehicle axle.

The measurement variables are determined in particular by the coefficient of friction of the roadway condition. Other influencing factors, such as the wheel lock caused by a steering movement or a yaw moment occurring on the vehicle, can indirectly influence the measurement variable. The deflection specified by the vehicle can be determined, for example, in a steer-by-wire system and in autonomous driving, and calculated from the inhomogeneity signal or taken into account by the control unit.

The method is used in particular in two-axle vehicles. Alternatively, the method is used in multi-axle vehicles. The method is carried out on at least two vehicle wheels located on the same vehicle axle. The method is preferably carried out on two vehicle axles, each with at least two vehicle wheels.

Each vehicle wheel preferably has a steering actuator arranged thereon. Each vehicle wheel particularly preferably has a wheel-selective steering actuator arranged thereon.

The vehicle can be steered by a driver or designed for autonomous driving.

The method for determining a roadway condition has the advantage that no further sensor system is required to determine the roadway condition, since in any case the steering actuators use existing values. This advantageously also results in a cost saving and a lower space requirement.

The vehicle having at least two wheel-selective steering actuators comprises at least two vehicle wheels, wherein the two vehicle wheels are arranged along the same axis. The vehicle wheels are mechanically and/or electrically coupled to one another. The vehicle axle can be continuous or consist of separate wheel carriers. One steering actuator is arranged on each vehicle wheel. Furthermore, the vehicle comprises a control unit which is in electrical connection with the steering actuators. The control unit is designed to carry out the previously described method for determining a roadway condition with all of its embodiments.

### BRIEF DESCRIPTION OF THE DRAWINGS

Further advantages, details, and developments will become apparent from the following description of a preferred embodiment, with reference to the accompanying drawings.

In the drawings:

FIG. 1 shows a schematic partial view of a vehicle wheel suspension system with a first embodiment of a wheel-selective steering actuator;

FIG. 2 shows a schematic partial view of a second embodiment of the wheel-selective steering actuator.

### DETAILED DESCRIPTION

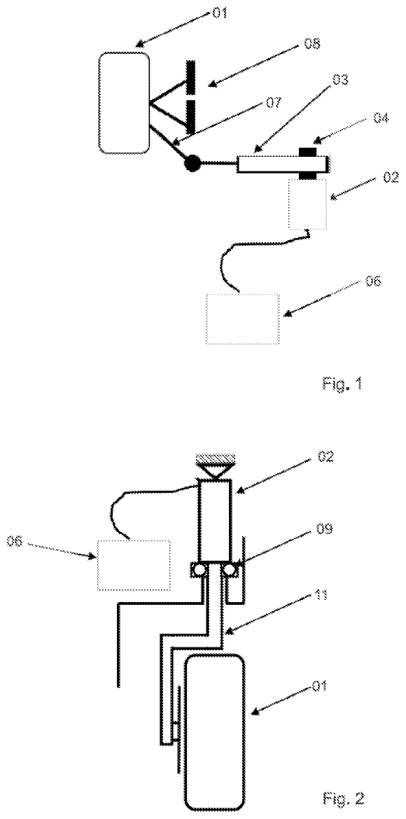

FIG. 1 shows a schematic partial view of a vehicle wheel suspension system with a first embodiment of a wheel-selective steering actuator or a wheel-selective vehicle steering system. The wheel-selective steering actuator can be used in a vehicle and is designed as a linear actuator. The steering actuator is arranged on a vehicle wheel 01 and comprises an electric motor 02, a rack 03 and a pinion 04, which is arranged between the rack 03 and the electric motor 02 and which serves as a connecting element. A control unit 06 is connected to the electric motor 02. The steering actuator is articulated to a reversing lever 07 by means of the rack 03. The reversing lever 07 engages the vehicle wheel 01 so that the steering actuator is connected to the vehicle wheel 01. The vehicle wheel suspension system also has a suspension arm 08, which is arranged on the vehicle wheel 01 and also forms the connection point to a vehicle body (not shown).

The wheel-selective steering actuator is designed to carry out the method for determining a roadway condition. At least two vehicle wheels 01 are arranged on a common vehicle axle (not shown), wherein a separate wheel-selective steering actuator is arranged on each vehicle wheel 01. The steering actuators are thus arranged on different sides of the vehicle (left, right).

The method provides that a measurement variable of the first steering actuator is determined in a first step and a measurement variable of the second steering actuator is determined in a further step. The measurement variables are sensed by means of a measuring device (not shown). The measuring device is arranged on the electric motor 02 or integrated thereinto. Alternatively, the measuring device can be arranged on the control unit 06 or integrated thereinto. Furthermore, the measuring device can also be integrated into the chassis. A motor current is sensed. In a further method step, the control unit 06 compares the sensed measurement variables from the two steering actuators. The control unit 06 determines an inhomogeneity signal from the deviation between the measurement variables, wherein an inhomogeneity signal lies within a tolerance range representing a homogeneous roadway condition and an inhomogeneity signal lies outside the tolerance range representing an inhomogeneous roadway condition. The determined inhomogeneity signal can be used to generate a compensation torque, for example a target drive torque and/or a braking torque and/or a target steering intervention, which can be used as an input variable in a vehicle control system or an assistance system. For example, a steering angle is set. The steering torque is determined using the sensed motor current as the measurement variable from the steering actuator. The steering torque can be calculated from the lateral force acting on the vehicle wheel 01 and the assigned lever arm by multiplication, wherein the lever arm is obtained from the addition of a tire caster with a structural caster. There is a functionally clear relationship between the motor current and the actuating force of the steering actuator.

FIG. 2 shows a schematic partial view of a second embodiment of the wheel-selective steering actuator. The wheel-selective steering actuator shown in FIG. 2 has the electric motor 02 or a modified electric motor with a transmission. The electric motor 02 is indirectly rotatably mounted on a roller bearing 09. The steering actuator also comprises the control unit 06, which is electrically connected to the electric motor 02. The electric motor 02 is mechanically and/or electrically coupled to the vehicle wheel 01 by means of a vehicle component 11 for setting a steering angle. The wheel-selective steering actuator is designed to carry out the method described in connection with FIG. 1 for determining a roadway condition. The steering torque is determined using the sensed motor current as the measurement variable from the steering actuator. In contrast to the determination of the steering torque described in FIG. 1, the steering torque to be determined in FIG. 2 corresponds to a motor torque. The motor torque can be calculated by multiplying the torque constant by the motor current.

### LIST OF REFERENCE SYMBOLS

01 Vehicle wheel
02 Electric motor

### 03 Rack

### 04 Pinion

06 Control unit
07 Reversing lever

### 08 Suspension arm

09 Roller bearing
11 Vehicle component

1. A method for determining a roadway condition by means of steering actuators, wherein first and second steering actuators are arranged on respective vehicle wheels assigned to a same vehicle axle, the method comprising:
sensing a measurement variable of the first steering actuator;
sensing a measurement variable of the second steering actuator;
comparing the sensed measurement variables of the two steering actuators;
determining an inhomogeneity signal from the deviation between the sensed measurement variables of the two steering actuators, wherein an inhomogeneity signal value within a tolerance range represents a homogeneous roadway condition and an inhomogeneity signal value outside the tolerance range represents an inhomogeneous roadway condition.

2. The method according to claim 1, wherein the first and second steering actuators each comprises an electric motor and a mechanical transmission element, and wherein the measurement variable is sensed on the electric motor.

3. The method according to claim 1, wherein the measurement variable is sensed as an actuating torque or an electrical current.

4. The method according to claim 1, wherein the measurement variable is determined by means of a measuring device associated with the steering actuator.

5. The method according to claim 2, wherein the electric motor of the steering actuator is connected to a control unit.

6. The method according to claim 1, further comprising using the determined inhomogeneity signal in a vehicle control system to stabilize the vehicle wheels and thus a vehicle.

7. The method according to claim 6, wherein the determined inhomogeneity signal is used to determine a target drive torque, wherein the target drive torque is impressed upon at least one of the vehicle wheels by the vehicle control system.

8. The method according to claim 1, wherein the method is used in a wheel-selective vehicle steering system.

9. The method according to claim 8, wherein the wheel-selective vehicle steering system is a steer-by-wire system.

10. A vehicle having at least two vehicle wheels which are arranged on a same axle, wherein a steering actuator is arranged on each of the two vehicle wheels, and having a control unit which is coupled to the steering actuators, wherein the control unit is programmed to carry out a method for determining a roadway condition according to claim 1.

11. The method according to claim 6, wherein the determined inhomogeneity signal is used to determine a braking torque, wherein the braking torque is impressed upon at least one of the vehicle wheels by the vehicle control system.

12. The method according to claim 6, wherein the determined inhomogeneity signal is used to determine a target steering intervention, wherein the target steering intervention is impressed upon at least one of the vehicle wheels by the vehicle control system.

13. A vehicle comprising:
first and second wheels;
first and second steering actuators configured to steer the first and second wheels respectively; and
a vehicle control system configured to sense a measurement variable on each of the first and second actuators, compare the measurement variables, and apply a stabilizing action to at least one of the two wheels in response to a difference between the measurement variables.

14. The vehicle of claim 13, wherein the measurement variable is a steering torque.

15. The vehicle of claim 13, wherein the measurement variable is an electric current.

16. The vehicle of claim 13, wherein the stabilizing action is a drive torque.

17. The vehicle of claim 13, wherein the stabilizing action is a braking torque.

18. The vehicle of claim 13, wherein the stabilizing action is a steering torque.
